(19) United States
(12) Patent Application Publication
(10) Pub. No.: US 2026/0095360 A1
(43) Pub. Date: Apr. 2, 2026

(54) FREQUENCY ERROR ESTIMATION AND PILOT SPACING IN ORTHOGONAL FREQUENCY DIVISION MULTIPLEXING SYSTEMS.

(71) Applicant: QUALCOMM Incorporated, San Diego, CA (US)

(72) Inventors: Ravinder KUMAR, San Diego, CA (US); Paolo MINERO, La Jolla, CA (US); Shamman NOOR SHOUDHA, Oceanside, CA (US); Subramanya P.N. RAO, Sunnyvale, CA (US); Jae Ho RYU, San Diego, CA (US); Yi HUANG, San Diego, CA (US)

(21) Appl. No.: 19/342,298

(22) Filed: Sep. 26, 2025

Related U.S. Application Data
(60) Provisional application No. 63/700,004, filed on Sep. 27, 2024.

(51) Int. Cl. H04L 27/26; H04L 27/00

(52) U.S. Cl. CPC H04L 27/2613; H04L 27/0014; H04L 2027/0026

(57) ABSTRACT

Methods, systems, and devices for wireless communications are described. Generally, the described techniques may enable a user equipment (UE) to use a frequency estimator (e.g., a maximum likelihood estimator) that may be based on a pilot signal sent over M distinct symbols. That is, the frequency estimator may be based on all available cross-correlations of pilot signals in a reference signal. In some examples, the frequency estimator may achieve an increased pull-in range and estimation performance based on weighting the available cross-correlations in accordance with the channel statistics. The described techniques may also support asymmetrical symbol spacings between pilot signals in one or more reference signals, which may further improve pull-in range of the frequency estimator. Additionally, or alternatively, aspects of the frequency estimator may be combined with aspects of another frequency estimator to increase the pull-in range with relatively low computation complexity at the UE.

### CROSS REFERENCE

The present Application for Patent claims the benefit of U.S. Provisional Patent Application No. 63/700,004 by KUMAR et al., entitled “FREQUENCY ERROR ESTIMATION AND PILOT SPACING IN ORTHOGONAL FREQUENCY DIVISION MULTIPLEXING SYSTEMS,” filed Sep. 27, 2024, and assigned to the assignee hereof. U.S. Provisional Application 63/700,004 is expressly incorporated by reference herein in its entirety.

### FIELD OF TECHNOLOGY

The following relates to wireless communications, including frequency error estimation and pilot spacing in orthogonal frequency division multiplexing systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may adjust a frequency tracking loop based receiving reference signals and on carrier frequency error associated with the reference signals.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a tracking reference signal (TRS) burst that includes three or more reference signal resources, where the three or more reference signal resources are positioned asymmetrically across one or more slots, and where a greatest common denominator (GCD) of a quantity of symbols between combinations of the three or more reference signal resources is one, estimating a carrier frequency offset (CFO) based on the three or more reference signal resources, and participating in communications based on the CFO estimation.

A UE for wireless communications is described. The UE may include one or more memories storing processor executable code, and one or more processors coupled with the one or more memories. The one or more processors may individually or collectively be operable to execute the code to cause the UE to receive a TRS burst that includes three or more reference signal resources, where the three or more reference signal resources are positioned asymmetrically across one or more slots, and where a GCD of a quantity of symbols between combinations of the three or more reference signal resources is one, estimate a CFO based on the three or more reference signal resources, and participate in communications based on the CFO estimation.

Another UE for wireless communications is described. The UE may include means for receiving a TRS burst that includes three or more reference signal resources, where the three or more reference signal resources are positioned asymmetrically across one or more slots, and where a GCD of a quantity of symbols between combinations of the three or more reference signal resources is one, means for estimating a CFO based on the three or more reference signal resources, and means for participating in communications based on the CFO estimation.

A non-transitory computer-readable medium storing code for wireless communications is described. The code may include instructions executable by one or more processors to receive a TRS burst that includes three or more reference signal resources, where the three or more reference signal resources are positioned asymmetrically across one or more slots, and where a GCD of a quantity of symbols between combinations of the three or more reference signal resources is one, estimate a CFO based on the three or more reference signal resources, and participate in communications based on the CFO estimation.

Some examples of the method, UEs, and non-transitory computer-readable medium described herein may further include operations, features, means, or instructions for adjusting a frequency tracking loop of the UE to compensate for the CFO estimation based on a pull-in range associated with the GCD, where participating in communications may be further based on adjusting the frequency tracking loop.

In some examples of the method, UEs, and non-transitory computer-readable medium described herein, a first slot of the one or more slots includes a first set of reference signal resources of the three or more reference signal resources and a second slot of the one or more slots includes a second set of reference signal resources of the three or more reference signal resources and the first set may be positioned asymmetrically in the first slot relative to the second set positioned in the second slot.

In some examples of the method, UEs, and non-transitory computer-readable medium described herein, the three or more reference signal resources may be positioned asymmetrically within one slot of the one or more slots and a spacing of the quantity of symbols between each of the three or more reference signal resources may be non-uniform.

In some examples of the method, UEs, and non-transitory computer-readable medium described herein, estimating the CFO may include operations, features, means, or instructions for determining one or more weights for one or more cross-correlation terms of multiple pair combinations of the three or more reference signal resources based on a channel associated with the TRS burst and summing the one or more weighted cross-correlation terms of the multiple pair combinations.

In some examples of the method, UEs, and non-transitory computer-readable medium described herein, each weight of the one or more weights may be further based on a Doppler frequency associated with the TRS burst and a product of a signal power and a normalized power of a respective independent tap of the channel. In some examples of the method, UEs, and non-transitory computer-readable medium described herein, the one or more cross-correlation terms of multiple pair combinations correspond to every pair combination of the three or more reference signal resources.

A method for wireless communications by a UE is described. The method may include receiving a TRS burst that includes two or more reference signal resources, estimating a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources, and participating in communications based on the CFO estimation.

A UE for wireless communications is described. The UE may include one or more memories storing processor executable code, and one or more processors coupled with the one or more memories. The one or more processors may individually or collectively be operable to execute the code to cause the UE to receive a TRS burst that includes two or more reference signal resources, estimate a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources, and participate in communications based on the CFO estimation.

Another UE for wireless communications is described. The UE may include means for receiving a TRS burst that includes two or more reference signal resources, means for estimating a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources, and means for participating in communications based on the CFO estimation.

A non-transitory computer-readable medium storing code for wireless communications is described. The code may include instructions executable by one or more processors to receive a TRS burst that includes two or more reference signal resources, estimate a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources, and participate in communications based on the CFO estimation.

Some examples of the method, UEs, and non-transitory computer-readable medium described herein may further include operations, features, means, or instructions for adjusting a frequency tracking loop of the UE to compensate for the CFO estimation based on a pull-in range associated with a GCD of the quantity of symbols, where participating in communications may be further based on adjusting the frequency tracking loop. In some examples of the method, UEs, and non-transitory computer-readable medium described herein, the one or more cross-correlation terms of multiple pair combinations correspond to every pair combination of the two or more reference signal resources.

In some examples of the method, UEs, and non-transitory computer-readable medium described herein, the two or more reference signal resources may be positioned asymmetrically across one or more slots. In some examples of the method, UEs, and non-transitory computer-readable medium described herein, a first slot of the one or more slots includes a first set of reference signal resources of the two or more reference signal resources and a second slot of the one or more slots includes a second set of reference signal resources of the two or more reference signal resources and the first set may be positioned asymmetrically in the first slot relative to the second set positioned in the second slot. In some examples of the method, UEs, and non-transitory computer-readable medium described herein, the two or more reference signal resources may be positioned asymmetrically within one slot of the one or more slots and a spacing of the quantity of symbols between each of the two or more reference signal resources may be non-uniform.

A method for wireless communications by a UE is described. The method may include receiving a TRS burst that includes two or more reference signal resources, estimating, via a first process, a CFO associated with the TRS burst based on the two or more reference signal resources, evaluating, via a second process, the CFO estimation at one or more aliasing points associated with the first process, where the second process is associated with weighted cross-correlation terms of the two or more reference signal resources, and where each weight is based on a Doppler frequency associated with the TRS burst, and participating in communications based on the CFO estimation.

A UE for wireless communications is described. The UE may include one or more memories storing processor executable code, and one or more processors coupled with the one or more memories. The one or more processors may individually or collectively be operable to execute the code to cause the UE to receive a TRS burst that includes two or more reference signal resources, estimate, via a first process, a CFO associated with the TRS burst based on the two or more reference signal resources, evaluate, via a second process, the CFO estimation at one or more aliasing points associated with the first process, where the second process is associated with weighted cross-correlation terms of the two or more reference signal resources, and where each weight is based on a Doppler frequency associated with the TRS burst, and participate in communications based on the CFO estimation.

Another UE for wireless communications is described. The UE may include means for receiving a TRS burst that includes two or more reference signal resources, means for estimating, via a first process, a CFO associated with the TRS burst based on the two or more reference signal resources, means for evaluating, via a second process, the CFO estimation at one or more aliasing points associated with the first process, where the second process is associated with weighted cross-correlation terms of the two or more reference signal resources, and where each weight is based on a Doppler frequency associated with the TRS burst, and means for participating in communications based on the CFO estimation.

A non-transitory computer-readable medium storing code for wireless communications is described. The code may include instructions executable by one or more processors to receive a TRS burst that includes two or more reference signal resources, estimate, via a first process, a CFO associated with the TRS burst based on the two or more reference signal resources, evaluate, via a second process, the CFO estimation at one or more aliasing points associated with the first process, where the second process is associated with weighted cross-correlation terms of the two or more reference signal resources, and where each weight is based on a Doppler frequency associated with the TRS burst, and participate in communications based on the CFO estimation.

Some examples of the method, UEs, and non-transitory computer-readable medium described herein may further include operations, features, means, or instructions for determining a pull-in range associated with the UE based on evaluating the CFO estimation via the second process and adjusting a frequency tracking loop of the UE to compensate for the CFO estimation based on the pull-in range, where participating in communications may be further based on adjusting the frequency tracking loop.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support frequency error estimation and pilot spacing in orthogonal frequency division multiplexing (OFDM) systems in accordance with one or more aspects of the present disclosure.

FIGS. 3A and 3B show examples of reference signal slot patterns that support frequency error estimation and pilot spacing in OFDM systems in accordance with one or more aspects of the present disclosure.

FIG. 4 shows an example of a block diagram that supports frequency error estimation and pilot spacing in OFDM systems in accordance with one or more aspects of the present disclosure.

FIG. 5 shows an example of a process flow that supports frequency error estimation and pilot spacing in OFDM systems in accordance with one or more aspects of the present disclosure.

FIGS. 6 and 7 show block diagrams of devices that support frequency error estimation and pilot spacing in OFDM systems in accordance with one or more aspects of the present disclosure.

FIG. 8 shows a block diagram of a communications manager that supports frequency error estimation and pilot spacing in OFDM systems in accordance with one or more aspects of the present disclosure.

FIG. 9 shows a diagram of a system including a device that supports frequency error estimation and pilot spacing in OFDM systems in accordance with one or more aspects of the present disclosure.

FIGS. 10 through 12 show flowcharts illustrating methods that support frequency error estimation and pilot spacing in OFDM systems in accordance with one or more aspects of the present disclosure.

### DETAILED DESCRIPTION

In some wireless communications systems, a user equipment (UE) may receive reference signals from a network entity, such as a tracking reference signal (TRS) burst, to mitigate a frequency error associated with communication signaling between the UE and the network entity. For example, communications between the UE and the network entity may degrade based on the frequency error of a communication channel. The reference signals may include one or more pilot signals that the UE may use to estimate carrier frequency offset (CFO). The UE may estimate the CFO using a frequency estimator. Based on estimating the CFO, the UE may adjust a frequency tracking loop to mitigate the CFO. However, in other systems, there may be a trade-off between an accuracy of the frequency estimator and a pull-in range of the frequency estimator based on a symbol spacing between two pilot signals. That is, increasing the pilot spacing may increase accuracy at the cost of a reduced pull-in range. Pull-in range may be the maximum frequency error the UE may estimate before aliasing (e.g., frequencies outside of the pull-in range may be aliased). Accordingly, it may be beneficial to use a frequency estimator that may achieve improved pull-in range and accuracy.

The techniques described herein may enable a UE to use a frequency estimator (e.g., a maximum likelihood estimator) that may be based on a pilot signal sent over M distinct symbols. That is, the frequency estimator described herein may be based on all available cross-correlations of pilot signals in a reference signal. In some examples, the frequency estimator may achieve an increased pull-in range and estimation performance based on weighting the available cross-correlations in accordance with the channel statistics. The techniques described herein may also support asymmetrical symbol spacings between pilot signals in one or more reference signals, which may further improve pull-in range of the frequency estimator. Additionally, or alternatively, aspects of the frequency estimator may be combined with aspects of another frequency estimator to increase the pull-in range with relatively low computation complexity at the UE.

Particular aspects of the subject matter described herein may be implemented to realize one or more advantages. In some examples, by combining all of the available cross-correlations of pilot signals in a reference signal, pull-in range and an accuracy of a frequency estimator of the UE may improve. As such, the UE may accurately mitigate CFO in communications between the UE and a network entity.

Aspects of the disclosure are initially described in the context of wireless communications systems. Aspects of the disclosure are also illustrated by and described with reference to reference signal slot patterns, a block diagram, and a process flow. Aspects of the disclosure are further illustrated by and described with reference to apparatus diagrams, system diagrams, and flowcharts that relate to frequency error estimation and pilot spacing in orthogonal frequency division multiplexing systems.

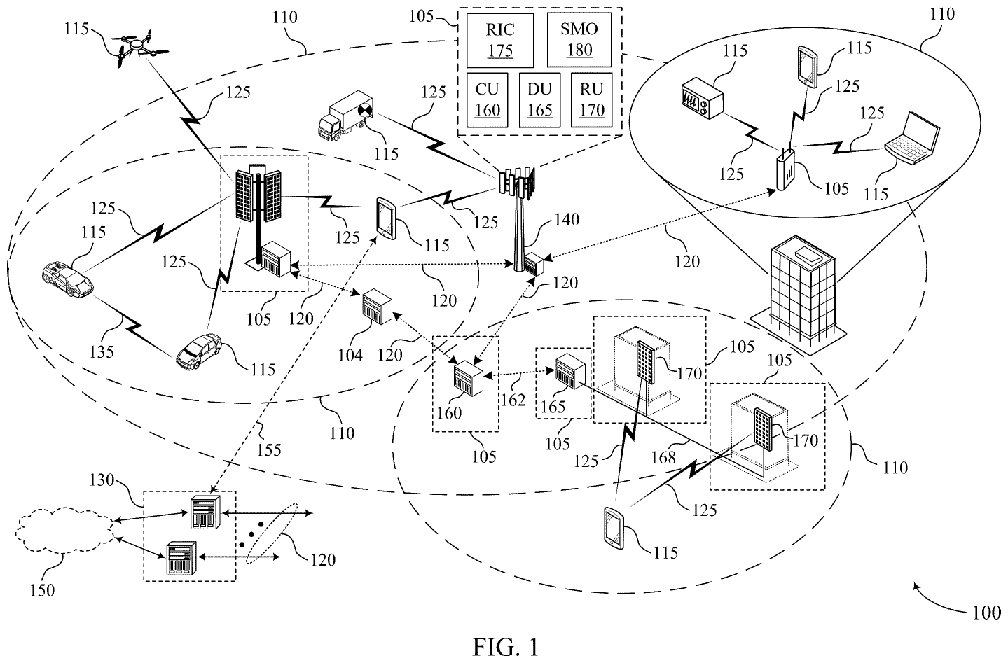

FIG. 1 shows an example of a wireless communications system 100 that supports frequency error estimation and pilot spacing in orthogonal frequency division multiplexing systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support frequency error estimation and pilot spacing in orthogonal frequency division multiplexing systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some wireless communications systems, a UE 115 may receive reference signals from a network entity 105, such as TRS burst, to mitigate a frequency error associated with communication signaling between the UE 115 and the network entity 105. For example, communications between the UE 115 and the network entity 105 may degrade based on the frequency error of a communication channel. The reference signals may include one or more pilot signals that the UE 115 may use to estimate CFO. The UE 115 may estimate the CFO using a frequency estimator. Based on estimating the CFO, the UE 115 may adjust a frequency tracking loop to mitigate the CFO. However, in other systems, there may be a trade-off between an accuracy of the frequency estimator and a pull-in range of the frequency estimator based on a symbol spacing between two pilot signals. That is, increasing the pilot spacing may increase accuracy at the cost of a reduced pull-in range. Pull-in range may be the maximum frequency error the UE 115 may estimate before aliasing (e.g., frequencies outside of the pull-in range may be aliased). Accordingly, it may be beneficial to use a frequency estimator that may achieve improved pull-in range and accuracy.

The techniques described herein may enable a UE 115 to use a frequency estimator (e.g., a maximum likelihood estimator) that may be based on a pilot signal sent over M distinct symbols. That is, the frequency estimator described herein may be based on all available cross-correlations of pilot signals in a reference signal. In some examples, the frequency estimator may achieve an increased pull-in range and estimation performance based on weighting the available cross-correlations in accordance with the channel statistics. The techniques described herein may also support asymmetrical symbol spacings between pilot signals in one or more reference signals, which may further improve pull-in range of the frequency estimator. Additionally, or alternatively, aspects of the frequency estimator may be combined with aspects of another frequency estimator to increase the pull-in range with relatively low computation complexity at the UE 115.

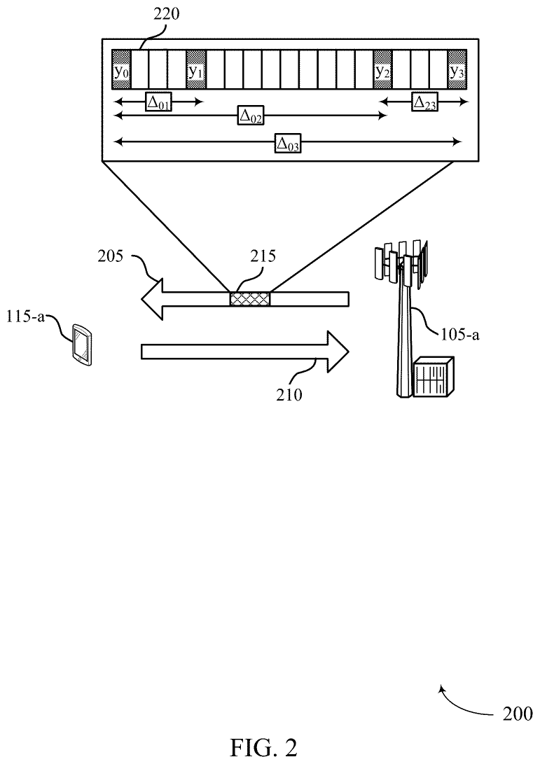

FIG. 2 shows an example of a wireless communications system 200 that supports frequency error estimation and pilot spacing in OFDM systems in accordance with one or more aspects of the present disclosure. The wireless communications system 200 may implement, or may be implemented by, aspects of the wireless communications system 100, as described herein with reference to FIG. 1. For example, the wireless communications system 100 may include a UE 115-a and a network entity 105-a, which may be examples of the corresponding devices described herein, including with reference to FIG. 1.

In some examples, the UE 115-a may receive one or more downlink transmissions 205, transmit one or more uplink transmissions 210, or both. For example, the UE 115-a may receive one or more reference signals 215 that include multiple OFDM symbols 220 and one or more pilot signals, y (e.g., one or more reference signal resources or TRS symbols) that support frequency error estimation as described herein. In some cases, the one or more reference signals 215 may be a TRS burst (e.g., one or more TRS) or one or more synchronization signal blocks (SSBs).

In some wireless communications systems, CFO may impact one or more frequency-domain tones. For example, CFO may result in attenuation in subcarrier energy based on an offset in a frequency sampling point (e.g., offset from a frequency normalized to subcarrier spacing (SCS)). In some examples, common phase error (CPE) may occur across multiple (e.g., all) subcarriers based on phase rotation from one OFDM symbol 220 to another. Frequency error within an OFDM symbol 220 may result in inter-carrier interference (ICI). That is, the CFO, \hat{X}ₜ[f], may be based on a combination of subcarrier energy attenuation, Xₜ[f], CPE across multiple subcarriers, f(∈), and ICI, I[F], as seen in equation 1:

$${\hat{X}}_{t} [ f ] = {X}_{t} [ f ] f ( ϵ ) {e}^{i 2 πϵ t} + I [ f ] \qquad ( 1 )$$

where ∈ is the frequency error normalized to the SCS of the one or more reference signals 215, t is the OFDM symbol index in time, f is the respective frequency tone, and e^{i2π∈t} is a phase ramp in the time domain based on the frequency error of the one or more reference signals 215.

In some examples, a local oscillator (LO) frequency offset at a transceiver, receiver, or both, of the UE 115-a may cause CFO. For example, the LO frequency may drift (e.g., degrade) from a nominal frequency of oscillation based on changes in temperature (e.g., ambient and/or internal temperature of the UE 115-a). Additionally, or alternatively, a Doppler shift experienced by the UE 115-a may result in CFO. That is, CFO may be result from a relative motion between a transmitter and receiver, such as between the UE 115-a and the network entity 105, or vice versa.

In some examples, the UE 115-a may reduce a performance impact caused by CFO. For example, the UE 115-a may include a frequency tracking loop (e.g., in a modem of the UE 115-a) that continuously estimates and corrects the CFO. That is, the frequency tracking loop may remove or compensate for the CPE and mitigate ICI. A pull-in range of the UE 115-a may be the range of frequency offsets in which the UE 115-a may synchronize the received signal with the LO. That is, the pull-in range may be the maximum frequency error the UE 115-a may estimate from a frequency estimator (e.g., frequencies outside the pull-in range may be aliased).

In some other wireless communications systems, a UE 115 may estimate the CFO in accordance with a first frequency estimator using a first estimation equation:

$$\hat{ϵ} = {arg max}_{ϵ} ℜ [ {y}_{0} {y}_{1}^{*} {e}^{- i 2 πϵΔ} ] \qquad ( 2 )$$

where

$${y}_{0} {y}_{1}^{*}$$

is the cross-correlation between the pilot signals y₀ and y₁ and Δ is the quantity of OFDM symbols 220 (or symbol spacing) between each of the pilot signals y₀ and y₁ (e.g., y* may be the conjugate of a respective pilot signal y). At relatively high SNRs, a variance of the first frequency estimator, E, may be proportional to the inverse square of the symbol spacing (e.g., the quantity of symbols 220 between respective pilot signals y). That is:

$$E [ {\vert ϵ - \hat{ϵ} \vert}^{2} ] ∝ \frac{1}{{Δ}^{2}} \qquad ( 3 )$$

A pull-in range of the first frequency estimator may be relatively limited because the first estimation equation may estimate errors such that:

$$\vert \hat{ϵ} \vert \leq \frac{1}{2 Δ} \qquad ( 4 )$$

That is, the first frequency estimator may not distinguish between ∈ and

$$ϵ \pm \frac{1}{Δ}$$

because of the periodicity of the phase ramp, e^{-i2π∈Δ}, in equation 2. In accordance with equations 3 and 4, changing the symbol spacing Δ between respective pilot signals may enable a trade-off between estimation performance and pull-in range. For example, decreasing Δ may increase the pull-in range (e.g., according to equation 4) while decreasing the accuracy of the estimation (e.g., according to equation 3), and vice versa.

In some examples, a UE 115 may use the one or more reference signals 215 for frequency error information. For example, the one or more reference signals 215 may be one or more CSI-RS for tracking, such as TRS. In some cases, a TRS may span two slots, with each slot comprising two pilot signals, y. In the example of FIG. 2, the UE 115-a may receive a TRS burst with relative distances Δ (e.g., pilot spacing or symbol spacing) between respective pilot signals y. For example, Δ₀₁ may be the relative distance in OFDM symbols between the pilot signal y₀ and y₁, Δ₀₂ may be the relative distance in OFDM symbols between the pilot signal y₀ and y₂, Δ₀₃ may be the relative distance in OFDM symbols between the pilot signal y₀ and y₃, and Δ₂₃ may be the relative distance in OFDM symbols between the pilot signal y₂ and y₃. In some examples, by applying equation 2 on a pair of pilot signals (e.g.,

$${y}_{0} {y}_{1}^{*} and / or {y}_{2} {y}_{3}^{*} )$$

with a symbol spacing Δ=4, a maximum pull-in range for TRS may be

$$\vert \hat{ϵ} \vert \leq \frac{1}{8}$$

according to equation 4. Inter-slot correlations (e.g., y₀ and y₂ and/or y₁ and y₃) may improve accuracy but at the cost of the pull-in range based on the larger symbol spacing Δ (e.g., Δ₀₂ may be 14 symbols and Δ₀₃ may be 18 symbols). Thus, it may be beneficial for a frequency estimator to achieve higher pull-in range and accuracy compared to the first frequency estimator.

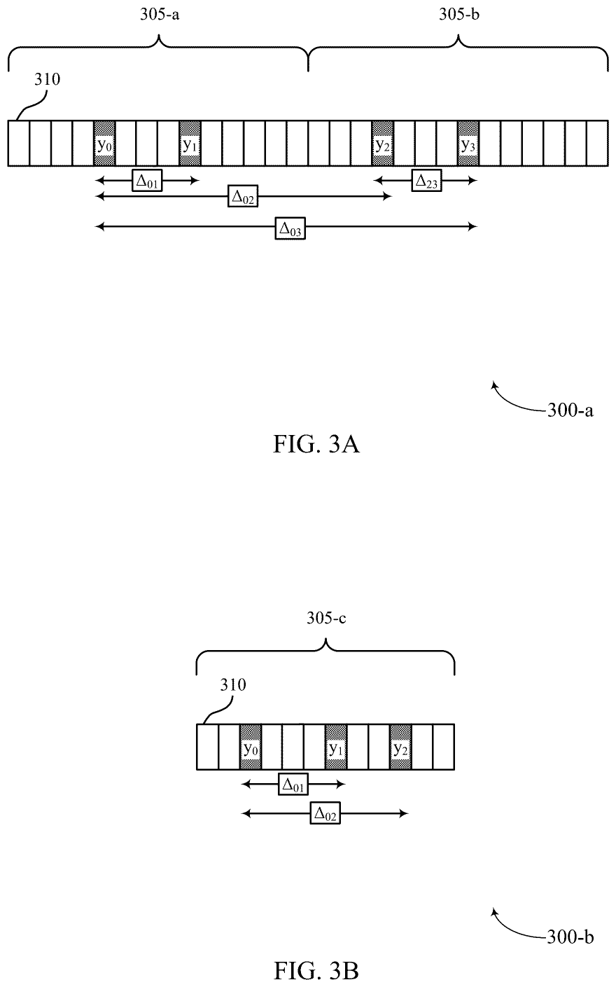

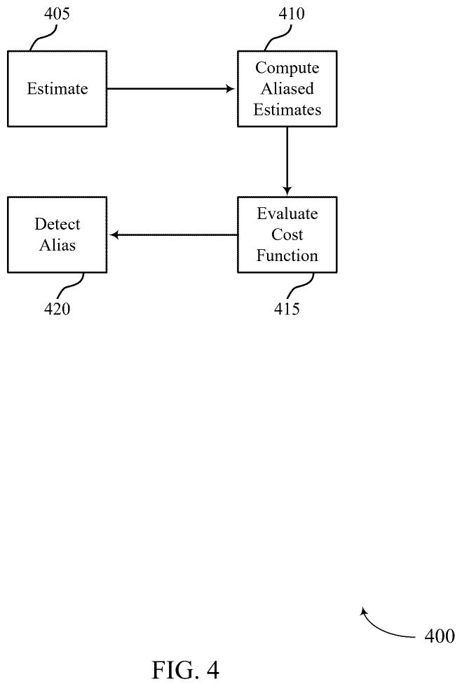

The techniques described herein may enable the UE 115-a to use a second frequency estimator (e.g., a maximum likelihood estimator) that may be based on a pilot signal y sent over M distinct OFDM symbols (e.g., compared to being based on M=2 distinct OFDM symbols in the first frequency estimator). In some examples, the second frequency estimator may achieve an increased pull-in range and estimation performance compared to the first frequency estimator (e.g., pull-in range for the same symbol spacing may be twice that of the first frequency estimator in some cases). As described further with reference to FIGS. 3A and 3B, pull-in range may increase further based on asymmetrical symbol spacings between pilot signals in the one or more reference signals 215. Additionally, or alternatively, as described further with reference to FIG. 4, aspects of the second frequency estimator may be combined with aspects of the first frequency estimator to increase the pull-in range with relatively low computation complexity at the UE 115-a.

The second frequency estimator may use a second estimation equation:

$$\hat{ε} = {argmax}_{ϵ} ℛ \{ {\sum }_{j , ∈ S} {w}_{j , k} {y}_{j} {y}_{k}^{*} {e}^{- i 2 π ϵ {Δ}_{j , k} β} \} \qquad ( 5 )$$

where S={(j,k):1≤j<k≤M} and is a set of all two-combinations in {1, 2, . . . , M}, Δ_{j,k} is the symbol spacing (e.g., time difference) between pilot signals yⱼ and yₖ, w_{j,k} is the weight associated with each of the

$$( \begin{matrix}M \\ 2\end{matrix} )$$

correlations, and

$$β = \frac{N + {N}_{C P}}{N}$$

where N is a size of a fast Fourier transform (e.g., effective OFDM symbol length) and N_{CP} is a cyclic prefix length. In some examples, the weight, w_{j,k}, may be equivalent to −[Γ⁻¹]_{j,k}, where Γ∈C^{M×N} and is the channel cross-correlation matrix (e.g., the channel of the one or more reference signals 215). In a first example, when M=4, the argument to be maximized in equation 5 becomes a sum of six weighted cross-correlation terms

$${y}_{0} {y}_{1}^{*} , {y}_{0} {y}_{2}^{*} , {y}_{0} {y}_{3}^{*} , {y}_{1} {y}_{2}^{*} , {y}_{1} {y}_{3}^{*} , and {y}_{2} {y}_{3}^{*} .$$

That is, the second frequency estimator may use all available cross-correlations and combine them using the weight function, w, that is based on channel statistics (e.g., the channel cross-correlation matrix).

In some examples, the weight function for a k-th receiver (e.g., of the UE 115-a) and an i-th channel tap may be expressed as:

$${w}_{k , i} = \frac{{J}_{0} {λ}_{k , i}}{{( {λ}_{k , i} + {σ}_{k}^{2} )}^{2} - {J}_{0}^{2} {λ}_{k , i}^{2}} \qquad ( 6 )$$

where σ is the noise in the one or more reference signals 215, and each weight is based on a Doppler frequency spread in the channel, f_{D}, and pilot symbol time separation, Δα, in the term J₀, where J₀=J₀(2πf_{D}Aα). A product of normalized power of an n-th independent tap of the channel for the k-th receiver (Rx), α_{k,n} and signal power, P, may be λ_{k,i}=Pα_{k,i}. In some cases (e.g., for zero Doppler), where J₀=1, each of the weights may be:

$$w = \frac{λ}{{( λ + {σ}^{2} )}^{2} - {λ}^{2}} = \frac{λ}{{σ}^{4} + 2 λ {σ}^{2}} = \frac{1}{{σ}^{2}} \frac{α snr}{1 + 2 α snr} [ s n r = \frac{P}{{σ}^{2}} ]$$

In an example with three pilot signals (e.g., three symbols), the weights may become:

$${w}_{01} = {w}_{02} = {w}_{12} = \frac{1}{{σ}^{2}} \frac{α s n r}{1 + 3 α snr}$$

at zero Doppler, where J₀₁=J₀₂=J₁₂=1.

In some examples, the second frequency estimator may result in a relatively low mean squared error (e.g., compared to the first frequency estimator). The Cramer Rao Bound (CRM) for the second frequency estimator may be evaluated to find that:

$$E [ \vert ϵ - \hat{ϵ} \vert ] ∝ \frac{1}{{\sum }_{j , k ∈ S} {w}_{j , k} {Δ}_{j , k}^{2}} \qquad ( 7 )$$

Equation 7 may be based on equation 3, and may illustrate that all cross-correlation terms may contribute to increasing the accuracy of the second frequency estimator. Additionally, or alternatively, the second frequency estimator may result in improved high-SNR performance. For example, the second frequency error may experience an increased SNR gain based on combining all the pilot signals, y (e.g., compared to using the two closest pilot signals in the first frequency estimator).

In some examples, the pull-in range of the second frequency estimator may be based on the greatest common denominator (GCD) (e.g., greatest common factor) of the symbol spacings, Δ:

$$\vert \hat{ϵ} \vert \leq \frac{1}{2 gcd ( {Δ}_{k , j} )} \qquad ( 8 )$$

For example, for Δ₀₁=4, Δ₀₂=14, Δ₀₃=18, and Δ₂₃=4, the GCD of the symbol spacings is 2, resulting in a pull-in range of

$$\vert \hat{ϵ} \vert \leq \frac{1}{4} .$$

As described further with reference to FIGS. 3A and 3B, the pull-in range may be increased based on placing the pilot signals y (e.g., TRS symbols) such that the GCD of the relative symbol spacing is one.

FIGS. 3A and 3B show examples of reference signal slot patterns 300 that support frequency error estimation and pilot spacing in OFDM systems in accordance with one or more aspects of the present disclosure. In the examples of FIGS. 3A and 3B, a network entity may transmit one or more reference signals (e.g., one or more reference signals 215) across one or more slots 305 for a UE to receive. The one or more reference signals may include OFDM symbols 310 and one or more pilot signals, y. For example, the UE may receive the one or more reference signals and use the one or more pilot signals in accordance with the second frequency estimator as described with reference to FIG. 2. The network entity and the UE may be examples of a network entity 105 and a UE 115 as described herein.

In some examples, the one or more reference signals may be a TRS burst. In such examples, the UE may perform time-frequency tracking and may estimate long-term channel parameters for channel estimation based on receiving the TRS burst. Based on the second frequency estimator, the reference signal slot patterns 300 may improve a capability of the UE to estimate and correct frequency error (e.g., CFO).

FIG. 3A illustrates a first reference slot pattern 300-a. The first reference slot pattern 300-a may illustrate an example of a TRS burst spanning two consecutive slots 305. In the first reference slot pattern 300-a, the pilot signals y₀, y₁, y₂, and y₃ may be positioned asymmetrically across a first slot 305-a and a second slot 305-b. For example, the TRS burst may use symbols {4,8} for pilot signals y₀ and y₁ in the first slot 305-a and symbols {5,9} for pilot signals y₂, and y₃ in the second slot 305-b.

The pilot signals may be placed in the first slot 305-a and the second slot 305-b such that the GCD of the symbol spacings within the TRS burst is one. For example, for Δ₀₁=4, Δ₀₂=13, Δ₀₃=17, and Δ₂₃=4, the GCD of 4, 13, and 17 may be 1. Although the first reference slot pattern 300-a illustrates symbol spacings of 4, 13, 17, and 4 for each of the pilot signals, it may be understood that the techniques described herein may apply to any asymmetric placement of the pilot signals across two slots of the one or more slots 305.

FIG. 3B illustrates a second reference slot pattern 300-b. The second reference slot pattern 300-b may illustrate an example of a 1-slot TRS with three pilot signals per slot. Additionally, or alternatively, the symbol spacing between the pilot signals y₀, y₁, and y₂ may be non-uniform in the second reference slot pattern 300-b. For example, the TRS may use the second, sixth, and eighth OFDM symbols 310 for each of the pilot signals in a third slot 305-c.

The pilot signals may be placed in the third slot 305-c such that the GCD of the symbol spacings within the TRS burst is one. For example, for Δ₀₁=4 and Δ₀₂=7, the GCD of 4 and 7 may be 1. Although the second reference slot pattern 300-b illustrates symbol spacings of 4 and 7 for each of the pilot signals, it may be understood that the techniques described herein may apply to any asymmetric placement of three or more pilot signals within a slot 305.

FIG. 4 shows an example of a block diagram 400 that supports frequency error estimation and pilot spacing in OFDM systems in accordance with one or more aspects of the present disclosure. In some examples, the block diagram 400 may implement, or be implemented by, aspects of the wireless communications system 100 or the wireless communications system 200, as described herein with reference to FIGS. 1 and 2. For example, a UE may be configured to perform one or more operations of the block diagram 400.

In some examples, the UE may improve pull-in range with a relatively low computational cost based on the block diagram 400. For example, at 405, the UE may estimate a CFO of one or more reference signals (e.g., one or more reference signals 215) using equation 2. That is, the UE may estimate the CFO, \hat{∈}, based on the closest two OFDM symbols within the one or more reference signals (e.g., within TRS) or other pilot signals. At 410, the UE may compute aliased estimates based on the symbol spacing, Δ:

$$\hat{ε} \pm \frac{1}{Δ} \qquad ( 9 )$$

At 415, the UE may evaluate the cost function of the second frequency estimator using equation 5 at the aliased points determined using equation 9. That is, the UE may compute a joint frequency estimator cost function for true and aliased estimations:

$$f ( \hat{ε} ) , f ( \hat{ε} \pm \frac{1}{Δ} )$$

At 420, the UE may compare the two aliased estimations to detect aliasing. That is, the UE may determine that the estimate is aliased if:

$$f ( \hat{ε} \pm \frac{1}{Δ} ) > f ( \hat{ε} ) \qquad ( 10 )$$

For example, if the first frequency estimator estimates an error of −500 Hz using equation 2 for a 30 kHz SCS and a symbol spacing of Δ=4, the first frequency estimator may be unable to distinguish between-500 Hz and the aliased points-8 kHz and 7 kHz

$$( e . g . , - 500 Hz \pm \frac{30 kHz}{4}$$

based on equation 9). Based on evaluating the cost function using equation 9 at three points (e.g., −500 Hz, −8 kHz, and 7 kHz), the UE may detect that the estimator is aliased if the value of the cost function at 7 kHz or −8 kHz is higher than −500 Hz.

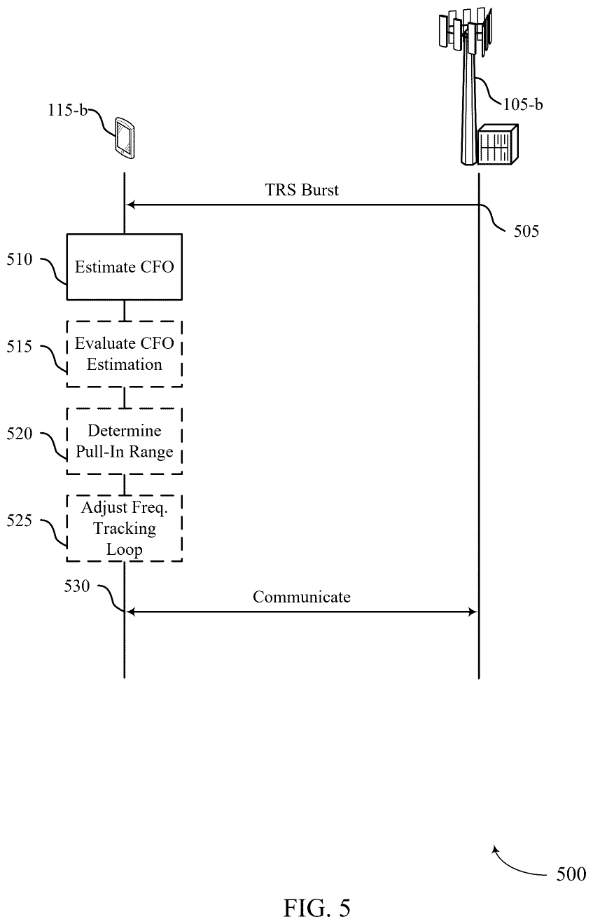

FIG. 5 shows an example of a process flow 500 that supports frequency error estimation and pilot spacing in OFDM systems in accordance with one or more aspects of the present disclosure. The process flow 500 may implement or be implemented by aspects of any of the wireless communications systems, reference slot patterns, or the block diagram described with reference to FIGS. 1 through 4. For example, the process flow 500 includes a network entity 105-b and a UE 115-b, which may be examples of corresponding devices described herein, including with reference to FIGS. 1 and 2. In the following description of the process flow 500, operations between the network entity 105-b and the UE 115-b may be added, omitted, or performed in a different order (with respect to the order shown).

At 505, the UE 115-b may receive a TRS burst that includes two or more reference signal resources (e.g., pilot signals, y). In some examples, the TRS burst may include three or more reference signal resources. In such examples, the three or more reference signal resources may be positioned asymmetrically across one or more slots and a GCD a quantity of symbols between combinations of the three or more reference signal resources may be one. Additionally, or alternatively, the two or more reference signal resources may be positioned asymmetrically across one or more slots. That is, the GCD of the symbol spacing between the two or more reference signal resources may be one (e.g., to increase pull-in range). As described herein, it may be understood that the two or more reference signals may include the three or more reference signals.

In some examples, the first slot of the one or more slots may include a first set of reference signal resources of the two or more reference signal resources, and a second slot of the one or more slots may include a second set of reference signal resources of the two or more reference signal resources. For example, the first slot may include a first set of two reference signal resources, y₀ and y₁, and the second slot may include two reference signal resources may include a second set of two reference resources, y₂ and y₃, as illustrated in FIG. 3A. The first set (e.g., y₀ and y₁) may be positioned asymmetrically in the first slot relative to the second set positioned in the second slot. Additionally, or alternatively, the two or more reference signal resources may be positioned asymmetrically within one slot of the one or more slots. For example, one slot may include three reference signal resources, y₀, y₁, and y₃, as illustrated in FIG. 3B. A spacing of the quantity of symbols between each of the three or more reference signals (e.g., the symbol spacing) may be non-uniform.

At 510, the UE 115-b may estimate a CFO based on the two or more reference signal resources. For example, the UE 115-b may determine one or more weights for one or more cross-correlation terms of multiple pair combinations of the two or more reference signal resources based on a channel associated with the TRS burst. In some cases, the one or more cross-correlation terms of multiple pair combinations may correspond to every pair combination (e.g., all possible pair combinations) of the two or more reference signal resources. That is, the UE 115-b may determine the one or more weights based on equation 6. The UE 115-b may estimate the CFO based on summing the one or more weighted cross-correlation terms of the multiple pair combinations (e.g., based on equation 5). In some examples, each weight of the one or more weights may be further based on a Doppler frequency associated with the TRS burst and a product of a signal power and a normalized power of a respective independent tap of the channel (e.g., as illustrated in equation 6).

In some examples, the UE 115-b may estimate the CFO associated with the TRS burst via a first process based on the two or more reference signal resources. For example, the UE 115-b may estimate the CFO in accordance with equation 2. In such examples, at 515, the UE 115-b may evaluate, via a second process, the CFO estimation at one or more aliasing points associated with the first process, as described further with reference to FIG. 4. The second process may be associated with weighted cross-correlation terms of the two or more reference signal resources and each weight may be based on a Doppler frequency associated with the TRS burst. For example, the UE 115-b may experience a Doppler shift based on a relative motion between the UE 115-b and the network entity 105-b (e.g., faster motion may result in higher Doppler shift and an increased Doppler frequency spread).

At 520, the UE 115-b may determine a pull-in range associated with the UE 115-b based on evaluating the CFO estimation via the second process. The pull-in range may be the range of frequency offsets within which the UE 115-b may synchronize the TRS burst with the LO of the UE 115-b. That is, the pull-in range may be the maximum frequency error the UE 115-b may estimate from a frequency estimator (e.g., the first frequency estimator or the second frequency estimator).

At 525, the UE 115-b may adjust a frequency tracking loop of the UE 115-b to compensate for the CFO estimation based on a pull-in range associated with the GCD (e.g., the GCD of the quantity of symbols). Additionally, or alternatively, the UE 115-b may adjust the frequency tracking loop based on the pull-in range. For example, the UE 115-b may include a modem that includes the frequency tracking loop. The modem may continuously estimate and correct the CFO (e.g., remove and/or compensate the CPE and reduce ICI below a threshold).

At 530, the UE 115-b may participate in communications based on the CFO estimation. For example, the UE 115-b may transmit and receive signaling to and from the network entity 105-b, respectively. In some examples, the UE 115-b may participate in communications based on adjusting the frequency tracking loop. Additionally, or alternatively, the UE 115-b may participate in communications based on evaluating the CFO estimation at the one or more aliasing points.

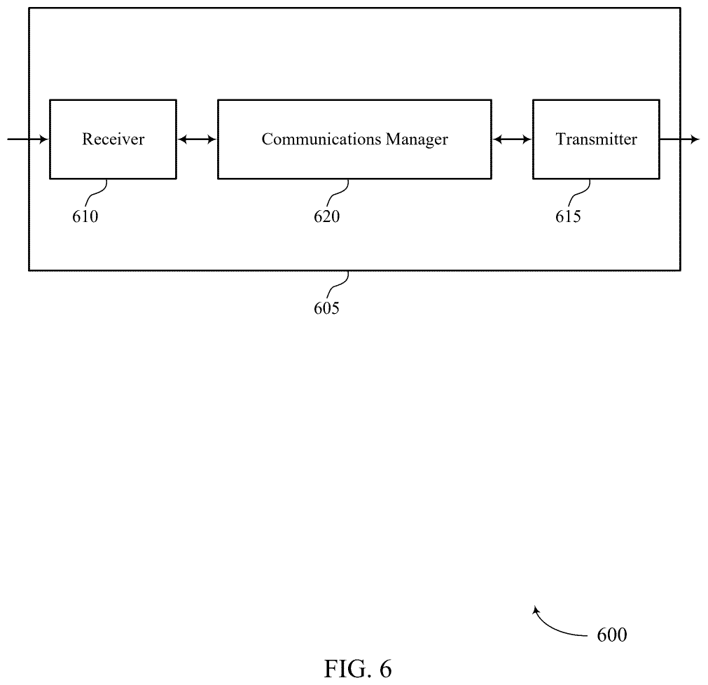

FIG. 6 shows a block diagram 600 of a device 605 that supports frequency error estimation and pilot spacing in OFDM systems in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to frequency error estimation and pilot spacing in OFDM systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to frequency error estimation and pilot spacing in OFDM systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of frequency error estimation and pilot spacing in OFDM systems as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a TRS burst that includes three or more reference signal resources, where the three or more reference signal resources are positioned asymmetrically across one or more slots, and where a GCD of a quantity of symbols between combinations of the three or more reference signal resources is one. The communications manager 620 is capable of, configured to, or operable to support a means for estimating a CFO based on the three or more reference signal resources. The communications manager 620 is capable of, configured to, or operable to support a means for participating in communications based on the CFO estimation.

Additionally, or alternatively, the communications manager 620 may support wireless communications in accordance with examples as disclosed herein. For example, the communications manager 620 is capable of, configured to, or operable to support a means for receiving a TRS burst that includes two or more reference signal resources. The communications manager 620 is capable of, configured to, or operable to support a means for estimating a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources. The communications manager 620 is capable of, configured to, or operable to support a means for participating in communications based on the CFO estimation.

Additionally, or alternatively, the communications manager 620 may support wireless communications in accordance with examples as disclosed herein. For example, the communications manager 620 is capable of, configured to, or operable to support a means for receiving a TRS burst that includes two or more reference signal resources. The communications manager 620 is capable of, configured to, or operable to support a means for estimating, via a first process, a CFO associated with the TRS burst based on the two or more reference signal resources. The communications manager 620 is capable of, configured to, or operable to support a means for evaluating, via a second process, the CFO estimation at one or more aliasing points associated with the first process, where the second process is associated with weighted cross-correlation terms of the two or more reference signal resources, and where each weight is based on a Doppler frequency associated with the TRS burst. The communications manager 620 is capable of, configured to, or operable to support a means for participating in communications based on the CFO estimation.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other examples.

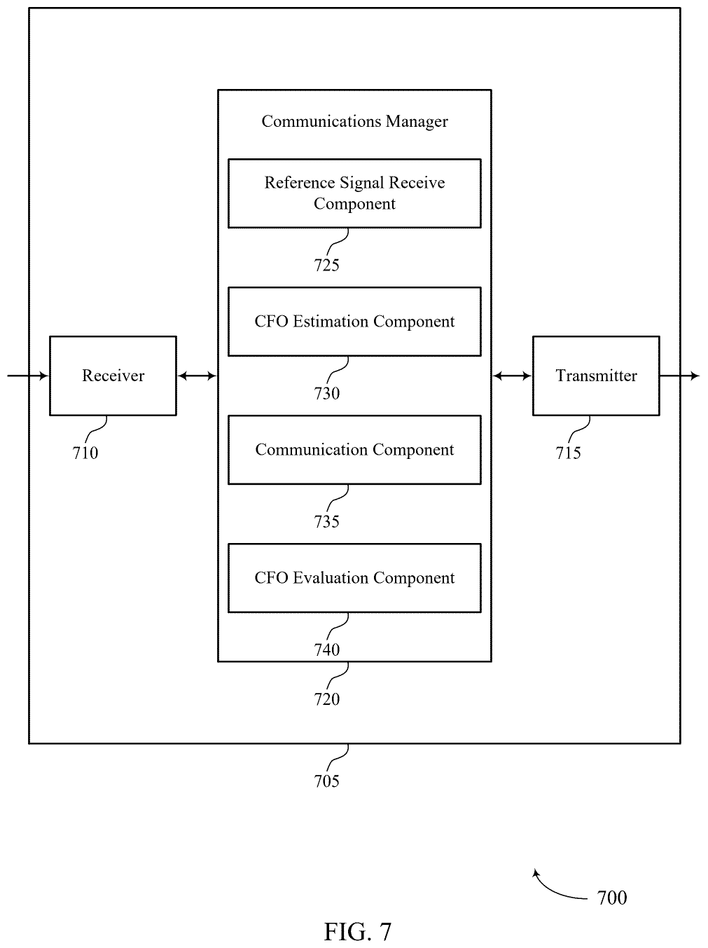

FIG. 7 shows a block diagram 700 of a device 705 that supports frequency error estimation and pilot spacing in OFDM systems in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to frequency error estimation and pilot spacing in OFDM systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to frequency error estimation and pilot spacing in OFDM systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of frequency error estimation and pilot spacing in OFDM systems as described herein. For example, the communications manager 720 may include a reference signal receive component 725, a CFO estimation component 730, a communication component 735, a CFO evaluation component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The reference signal receive component 725 is capable of, configured to, or operable to support a means for receiving a TRS burst that includes three or more reference signal resources, where the three or more reference signal resources are positioned asymmetrically across one or more slots, and where a GCD of a quantity of symbols between combinations of the three or more reference signal resources is one. The CFO estimation component 730 is capable of, configured to, or operable to support a means for estimating a CFO based on the three or more reference signal resources. The communication component 735 is capable of, configured to, or operable to support a means for participating in communications based on the CFO estimation.

Additionally, or alternatively, the communications manager 720 may support wireless communications in accordance with examples as disclosed herein. The reference signal receive component 725 is capable of, configured to, or operable to support a means for receiving a TRS burst that includes two or more reference signal resources. The CFO estimation component 730 is capable of, configured to, or operable to support a means for estimating a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources. The communication component 735 is capable of, configured to, or operable to support a means for participating in communications based on the CFO estimation.

Additionally, or alternatively, the communications manager 720 may support wireless communications in accordance with examples as disclosed herein. The reference signal receive component 725 is capable of, configured to, or operable to support a means for receiving a TRS burst that includes two or more reference signal resources. The CFO estimation component 730 is capable of, configured to, or operable to support a means for estimating, via a first process, a CFO associated with the TRS burst based on the two or more reference signal resources. The CFO evaluation component 740 is capable of, configured to, or operable to support a means for evaluating, via a second process, the CFO estimation at one or more aliasing points associated with the first process, where the second process is associated with weighted cross-correlation terms of the two or more reference signal resources, and where each weight is based on a Doppler frequency associated with the TRS burst. The communication component 735 is capable of, configured to, or operable to support a means for participating in communications based on the CFO estimation.

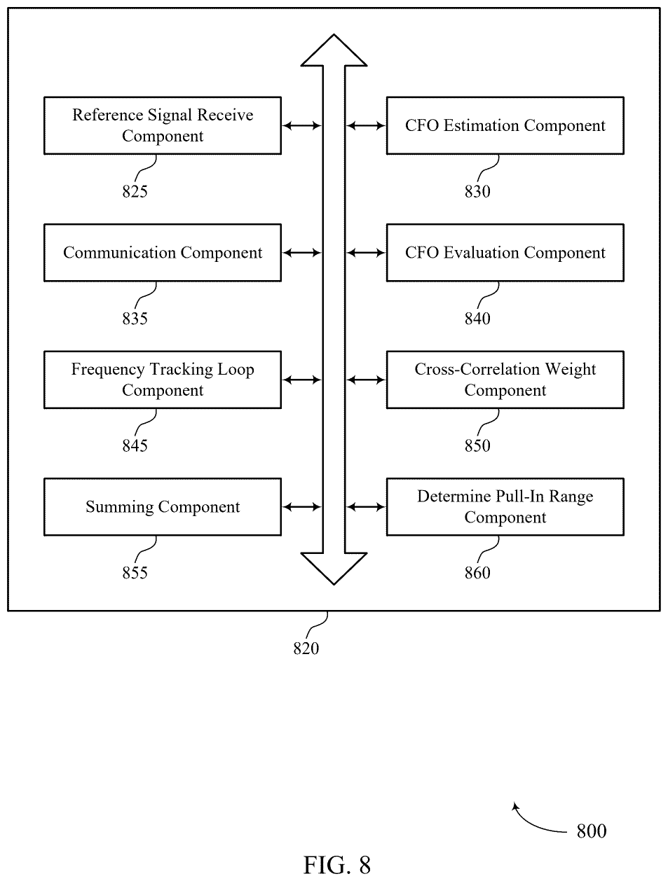

FIG. 8 shows a block diagram 800 of a communications manager 820 that supports frequency error estimation and pilot spacing in OFDM systems in accordance with one or more aspects of the present disclosure. The communications manager 820 may be an example of aspects of a communications manager 620, a communications manager 720, or both, as described herein. The communications manager 820, or various components thereof, may be an example of means for performing various aspects of frequency error estimation and pilot spacing in OFDM systems as described herein. For example, the communications manager 820 may include a reference signal receive component 825, a CFO estimation component 830, a communication component 835, a CFO evaluation component 840, a frequency tracking loop component 845, a cross-correlation weight component 850, a summing component 855, a determine pull-in range component 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The reference signal receive component 825 is capable of, configured to, or operable to support a means for receiving a TRS burst that includes three or more reference signal resources, where the three or more reference signal resources are positioned asymmetrically across one or more slots, and where a GCD of a quantity of symbols between combinations of the three or more reference signal resources is one. The CFO estimation component 830 is capable of, configured to, or operable to support a means for estimating a CFO based on the three or more reference signal resources. The communication component 835 is capable of, configured to, or operable to support a means for participating in communications based on the CFO estimation.

In some examples, the frequency tracking loop component 845 is capable of, configured to, or operable to support a means for adjusting a frequency tracking loop of the UE to compensate for the CFO estimation based on a pull-in range associated with the GCD, where participating in communications is further based on adjusting the frequency tracking loop.

In some examples, a first slot of the one or more slots includes a first set of reference signal resources of the three or more reference signal resources and a second slot of the one or more slots includes a second set of reference signal resources of the three or more reference signal resources. In some examples, the first set is positioned asymmetrically in the first slot relative to the second set positioned in the second slot. In some examples, the three or more reference signal resources are positioned asymmetrically within one slot of the one or more slots. In some examples, a spacing of the quantity of symbols between each of the three or more reference signal resources is non-uniform.

In some examples, to support estimating the CFO, the cross-correlation weight component 850 is capable of, configured to, or operable to support a means for determining one or more weights for one or more cross-correlation terms of multiple pair combinations of the three or more reference signal resources based on a channel associated with the TRS burst. In some examples, to support estimating the CFO, the summing component 855 is capable of, configured to, or operable to support a means for summing the one or more weighted cross-correlation terms of the multiple pair combinations.

In some examples, each weight of the one or more weights is further based on a Doppler frequency associated with the TRS burst and a product of a signal power and a normalized power of a respective independent tap of the channel. In some examples, the one or more cross-correlation terms of multiple pair combinations correspond to every pair combination of the three or more reference signal resources.

Additionally, or alternatively, the communications manager 820 may support wireless communications in accordance with examples as disclosed herein. In some examples, the reference signal receive component 825 is capable of, configured to, or operable to support a means for receiving a TRS burst that includes two or more reference signal resources. In some examples, the CFO estimation component 830 is capable of, configured to, or operable to support a means for estimating a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources. In some examples, the communication component 835 is capable of, configured to, or operable to support a means for participating in communications based on the CFO estimation.

In some examples, the frequency tracking loop component 845 is capable of, configured to, or operable to support a means for adjusting a frequency tracking loop of the UE to compensate for the CFO estimation based on a pull-in range associated with a GCD of the quantity of symbols, where participating in communications is further based on adjusting the frequency tracking loop. In some examples, the one or more cross-correlation terms of multiple pair combinations correspond to every pair combination of the two or more reference signal resources.

In some examples, the two or more reference signal resources are positioned asymmetrically across one or more slots. In some examples, a first slot of the one or more slots includes a first set of reference signal resources of the two or more reference signal resources and a second slot of the one or more slots includes a second set of reference signal resources of the two or more reference signal resources. In some examples, the first set is positioned asymmetrically in the first slot relative to the second set positioned in the second slot. In some examples, the two or more reference signal resources are positioned asymmetrically within one slot of the one or more slots. In some examples, a spacing of the quantity of symbols between each of the two or more reference signal resources is non-uniform.

Additionally, or alternatively, the communications manager 820 may support wireless communications in accordance with examples as disclosed herein. In some examples, the reference signal receive component 825 is capable of, configured to, or operable to support a means for receiving a TRS burst that includes two or more reference signal resources. In some examples, the CFO estimation component 830 is capable of, configured to, or operable to support a means for estimating, via a first process, a CFO associated with the TRS burst based on the two or more reference signal resources. The CFO evaluation component 840 is capable of, configured to, or operable to support a means for evaluating, via a second process, the CFO estimation at one or more aliasing points associated with the first process, where the second process is associated with weighted cross-correlation terms of the two or more reference signal resources, and where each weight is based on a Doppler frequency associated with the TRS burst. In some examples, the communication component 835 is capable of, configured to, or operable to support a means for participating in communications based on the CFO estimation.

In some examples, the determine pull-in range component 860 is capable of, configured to, or operable to support a means for determining a pull-in range associated with the UE based on evaluating the CFO estimation via the second process. In some examples, the frequency tracking loop component 845 is capable of, configured to, or operable to support a means for adjusting a frequency tracking loop of the UE to compensate for the CFO estimation based on the pull-in range, where participating in communications is further based on adjusting the frequency tracking loop.

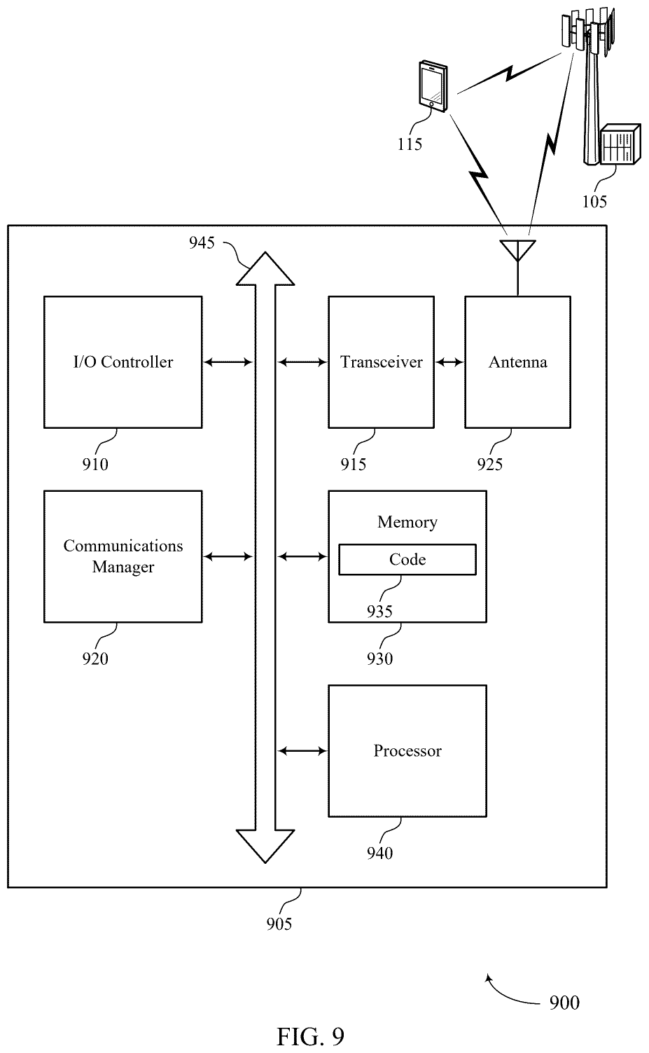

FIG. 9 shows a diagram of a system 900 including a device 905 that supports frequency error estimation and pilot spacing in OFDM systems in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting frequency error estimation and pilot spacing in OFDM systems). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a TRS burst that includes three or more reference signal resources, where the three or more reference signal resources are positioned asymmetrically across one or more slots, and where a GCD of a quantity of symbols between combinations of the three or more reference signal resources is one. The communications manager 920 is capable of, configured to, or operable to support a means for estimating a CFO based on the three or more reference signal resources. The communications manager 920 is capable of, configured to, or operable to support a means for participating in communications based on the CFO estimation.

Additionally, or alternatively, the communications manager 920 may support wireless communications in accordance with examples as disclosed herein. For example, the communications manager 920 is capable of, configured to, or operable to support a means for receiving a TRS burst that includes two or more reference signal resources. The communications manager 920 is capable of, configured to, or operable to support a means for estimating a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources. The communications manager 920 is capable of, configured to, or operable to support a means for participating in communications based on the CFO estimation.

Additionally, or alternatively, the communications manager 920 may support wireless communications in accordance with examples as disclosed herein. For example, the communications manager 920 is capable of, configured to, or operable to support a means for receiving a TRS burst that includes two or more reference signal resources. The communications manager 920 is capable of, configured to, or operable to support a means for estimating, via a first process, a CFO associated with the TRS burst based on the two or more reference signal resources. The communications manager 920 is capable of, configured to, or operable to support a means for evaluating, via a second process, the CFO estimation at one or more aliasing points associated with the first process, where the second process is associated with weighted cross-correlation terms of the two or more reference signal resources, and where each weight is based on a Doppler frequency associated with the TRS burst. The communications manager 920 is capable of, configured to, or operable to support a means for participating in communications based on the CFO estimation.

By including or configuring the communications manager 920 in accordance with examples as described herein, the device 905 may support techniques for improved communication reliability, reduced power consumption, more efficient utilization of communication resources, improved coordination between devices, and improved utilization of processing capability, among other examples.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of frequency error estimation and pilot spacing in OFDM systems as described herein, or the at least one processor 940 and the at least one memory 930 may be otherwise configured to, individually or collectively, perform or support such operations.

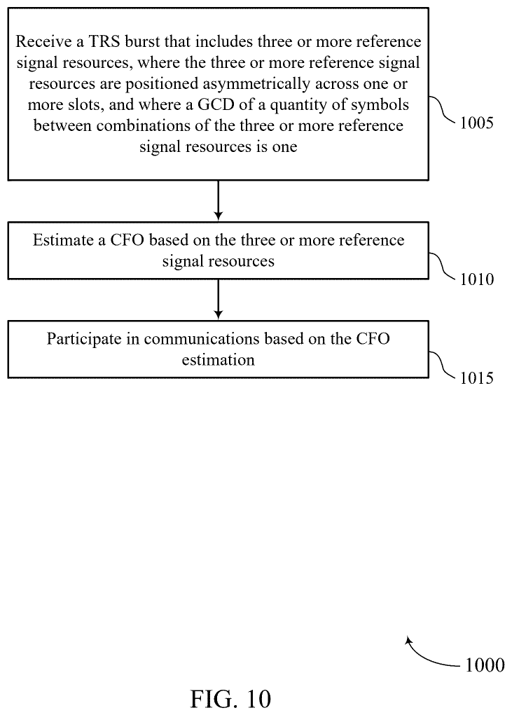

FIG. 10 shows a flowchart illustrating a method 1000 that supports frequency error estimation and pilot spacing in OFDM systems in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a TRS burst that includes three or more reference signal resources, where the three or more reference signal resources are positioned asymmetrically across one or more slots, and where a GCD of a quantity of symbols between combinations of the three or more reference signal resources is one. The operations of 1005 may be performed in accordance with examples as disclosed herein. In some examples, aspects of the operations of 1005 may be performed by a reference signal receive component 825 as described with reference to FIG. 8.

At 1010, the method may include estimating a CFO based on the three or more reference signal resources. The operations of 1010 may be performed in accordance with examples as disclosed herein. In some examples, aspects of the operations of 1010 may be performed by a CFO estimation component 830 as described with reference to FIG. 8.

At 1015, the method may include participating in communications based on the CFO estimation. The operations of 1015 may be performed in accordance with examples as disclosed herein. In some examples, aspects of the operations of 1015 may be performed by a communication component 835 as described with reference to FIG. 8.

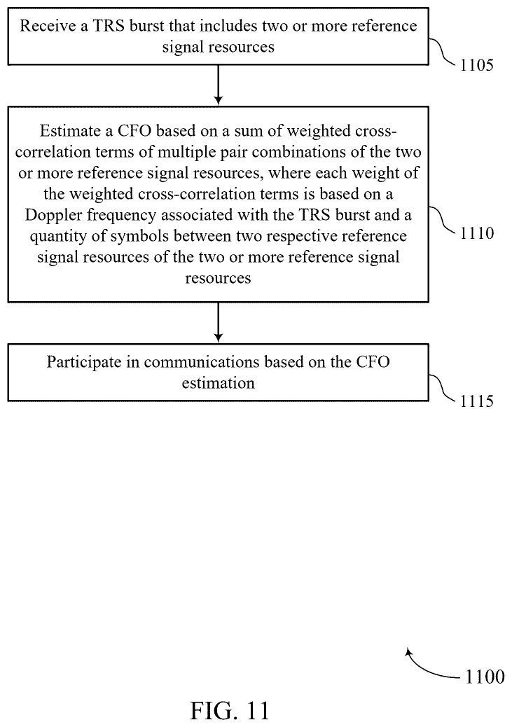

FIG. 11 shows a flowchart illustrating a method 1100 that supports frequency error estimation and pilot spacing in OFDM systems in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a TRS burst that includes two or more reference signal resources. The operations of 1105 may be performed in accordance with examples as disclosed herein. In some examples, aspects of the operations of 1105 may be performed by a reference signal receive component 825 as described with reference to FIG. 8.

At 1110, the method may include estimating a CFO based on a sum of weighted cross-correlation terms of multiple pair combinations of the two or more reference signal resources, where each weight of the weighted cross-correlation terms is based on a Doppler frequency associated with the TRS burst and a quantity of symbols between two respective reference signal resources of the two or more reference signal resources. The operations of 1110 may be performed in accordance with examples as disclosed herein. In some examples, aspects of the operations of 1110 may be performed by a CFO estimation component 830 as described with reference to FIG. 8.

At 1115, the method may include participating in communications based on the CFO estimation. The operations of 1115 may be performed in accordance with examples as disclosed herein. In some examples, aspects of the operations of 1115 may be performed by a communication component 835 as described with reference to FIG. 8.

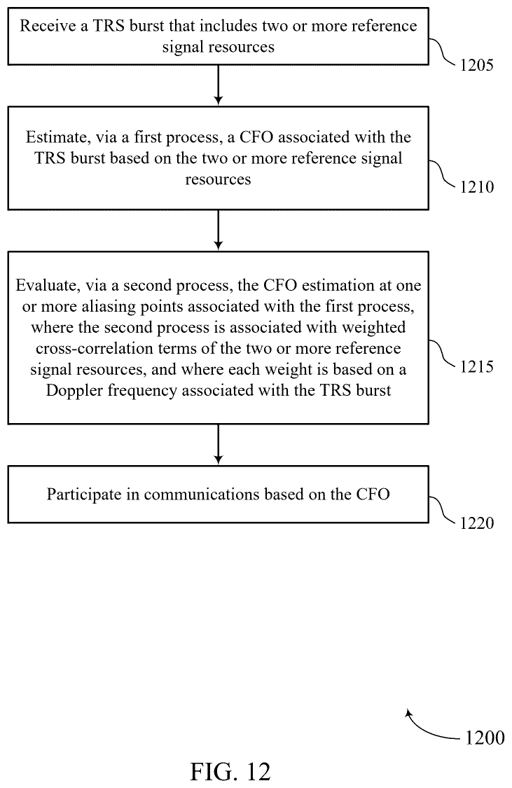

FIG. 12 shows a flowchart illustrating a method 1200 that supports frequency error estimation and pilot spacing in OFDM systems in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving a TRS burst that includes two or more reference signal resources. The operations of 1205 may be performed in accordance with examples as disclosed herein. In some examples, aspects of the operations of 1205 may be performed by a reference signal receive component 825 as described with reference to FIG. 8.

At 1210, the method may include estimating, via a first process, a CFO associated with the TRS burst based on the two or more reference signal resources. The operations of 1210 may be performed in accordance with examples as disclosed herein. In some examples, aspects of the operations of 1210 may be performed by a CFO estimation component 830 as described with reference to FIG. 8.

At 1215, the method may include evaluating, via a second process, the CFO estimation at one or more aliasing points associated with the first process, where the second process is associated with weighted cross-correlation terms of the two or more reference signal resources, and where each weight is based on a Doppler frequency associated with the TRS burst. The operations of 1215 may be performed in accordance with examples as disclosed herein. In some examples, aspects of the operations of 1215 may be performed by a CFO evaluation component 840 as described with reference to FIG. 8.

At 1220, the method may include participating in communications based on the CFO. The operations of 1220 may be performed in accordance with examples as disclosed herein. In some examples, aspects of the operations of 1220 may be performed by a communication component 835 as described with reference to FIG. 8. The following provides an overview of aspects of the present disclosure:

Aspect 1: A method for wireless communications at a UE, comprising: receiving a TRS burst that includes three or more reference signal resources, wherein the three or more reference signal resources are positioned asymmetrically across one or more slots, and wherein a GCD of a quantity of symbols between combinations of the three or more reference signal resources is one; estimating a CFO based at least in part on the three or more reference signal resources; and participating in communications based at least in part on the CFO estimation.

Aspect 2: The method of aspect 1, further comprising: adjusting a frequency tracking loop of the UE to compensate for the CFO estimation based at least in part on a pull-in range associated with the GCD, wherein participating in communications is further based at least in part on adjusting the frequency tracking loop.

Aspect 3: The method of any of aspects 1 through 2, wherein a first slot of the one or more slots comprises a first set of reference signal resources of the three or more reference signal resources and a second slot of the one or more slots comprises a second set of reference signal resources of the three or more reference signal resources, and the first set is positioned asymmetrically in the first slot relative to the second set positioned in the second slot.

Aspect 4: The method of any of aspects 1 through 3, wherein the three or more reference signal resources are positioned asymmetrically within one slot of the one or more slots, and a spacing of the quantity of symbols between each of the three or more reference signal resources is non-uniform.

Aspect 5: The method of any of aspects 1 through 4, wherein estimating the CFO comprises: determining one or more weights for one or more cross-correlation terms of multiple pair combinations of the three or more reference signal resources based at least in part on a channel associated with the TRS burst; and summing the one or more weighted cross-correlation terms of the multiple pair combinations.

Aspect 6: The method of aspect 5, wherein each weight of the one or more weights is further based at least in part on a Doppler frequency associated with the TRS burst and a product of a signal power and a normalized power of a respective independent tap of the channel.

Aspect 7: The method of any of aspects 5 through 6, wherein the one or more cross-correlation terms of multiple pair combinations correspond to every pair combination of the three or more reference signal resources.

Aspect 8: A method for wireless communications at a UE, comprising: receiving a TRS burst that includes two or more reference signal resources; estimating a CFO based at least in part on a sum of weighted cross-correlation terms of multiple pair combinations of the two or more reference signal resources, wherein each weight of the weighted cross-correlation terms is based at least in part on a Doppler frequency associated with the TRS burst and a quantity of symbols between two respective reference signal resources of the two or more reference signal resources; and participating in communications based at least in part on the CFO estimation.

Aspect 9: The method of aspect 8, further comprising: adjusting a frequency tracking loop of the UE to compensate for the CFO estimation based at least in part on a pull-in range associated with a GCD of the quantity of symbols, wherein participating in communications is further based at least in part on adjusting the frequency tracking loop.

Aspect 10: The method of any of aspects 8 through 9, wherein the one or more cross-correlation terms of multiple pair combinations correspond to every pair combination of the two or more reference signal resources.

Aspect 11: The method of any of aspects 8 through 10, wherein the two or more reference signal resources are positioned asymmetrically across one or more slots.

Aspect 12: The method of aspect 11, wherein a first slot of the one or more slots comprises a first set of reference signal resources of the two or more reference signal resources and a second slot of the one or more slots comprises a second set of reference signal resources of the two or more reference signal resources, and the first set is positioned asymmetrically in the first slot relative to the second set positioned in the second slot.

Aspect 13: The method of any of aspects 11 through 12, wherein the two or more reference signal resources are positioned asymmetrically within one slot of the one or more slots, and a spacing of the quantity of symbols between each of the two or more reference signal resources is non-uniform.

Aspect 14: A method for wireless communications at a UE, comprising: receiving a TRS burst that includes two or more reference signal resources; estimating, via a first process, a CFO associated with the TRS burst based at least in part on the two or more reference signal resources; evaluating, via a second process, the CFO estimation at one or more aliasing points associated with the first process, wherein the second process is associated with weighted cross-correlation terms of the two or more reference signal resources, and wherein each weight is based at least in part on a Doppler frequency associated with the TRS burst; and participating in communications based at least in part on the CFO estimation.

Aspect 15: The method of aspect 14, further comprising: determining a pull-in range associated with the UE based at least in part on evaluating the CFO estimation via the second process; and adjusting a frequency tracking loop of the UE to compensate for the CFO estimation based at least in part on the pull-in range, wherein participating in communications is further based at least in part on adjusting the frequency tracking loop.

Aspect 16: A UE for wireless communications, comprising one or more memories storing processor-executable code, and one or more processors coupled with the one or more memories and individually or collectively operable to execute the code to cause the UE to perform a method of any of aspects 1 through 7.

Aspect 17: A UE for wireless communications, comprising at least one means for performing a method of any of aspects 1 through 7.

Aspect 18: A non-transitory computer-readable medium storing code for wireless communications, the code comprising instructions executable by one or more processors to perform a method of any of aspects 1 through 7.

Aspect 19: A UE for wireless communications, comprising one or more memories storing processor-executable code, and one or more processors coupled with the one or more memories and individually or collectively operable to execute the code to cause the UE to perform a method of any of aspects 8 through 13.

Aspect 20: A UE for wireless communications, comprising at least one means for performing a method of any of aspects 8 through 13.

Aspect 21: A non-transitory computer-readable medium storing code for wireless communications, the code comprising instructions executable by one or more processors to perform a method of any of aspects 8 through 13.

Aspect 22: A UE for wireless communications, comprising one or more memories storing processor-executable code, and one or more processors coupled with the one or more memories and individually or collectively operable to execute the code to cause the UE to perform a method of any of aspects 14 through 15.

Aspect 23: A UE for wireless communications, comprising at least one means for performing a method of any of aspects 14 through 15.

Aspect 24: A non-transitory computer-readable medium storing code for wireless communications, the code comprising instructions executable by one or more processors to perform a method of any of aspects 14 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a tracking reference signal burst that includes three or more reference signal resources, wherein the three or more reference signal resources are positioned asymmetrically across one or more slots, and wherein a greatest common denominator of a quantity of symbols between combinations of the three or more reference signal resources is one;
estimate a carrier frequency offset (CFO) based at least in part on the three or more reference signal resources; and
participate in communications based at least in part on the CFO estimation.

2. The UE of claim 1, wherein the one or more processors are individually or collectively further operable to execute the code to cause the UE to:
adjust a frequency tracking loop of the UE to compensate for the CFO estimation based at least in part on a pull-in range associated with the greatest common denominator, wherein participating in communications is further based at least in part on adjusting the frequency tracking loop.

3. The UE of claim 1, wherein:
a first slot of the one or more slots comprises a first set of reference signal resources of the three or more reference signal resources and a second slot of the one or more slots comprises a second set of reference signal resources of the three or more reference signal resources, and
the first set is positioned asymmetrically in the first slot relative to the second set positioned in the second slot.

4. The UE of claim 1, wherein:
the three or more reference signal resources are positioned asymmetrically within one slot of the one or more slots, and
a spacing of the quantity of symbols between each of the three or more reference signal resources is non-uniform.

5. The UE of claim 1, wherein, to estimate the CFO, the one or more processors are individually or collectively operable to execute the code to cause the UE to:
determine one or more weights for one or more cross-correlation terms of multiple pair combinations of the three or more reference signal resources based at least in part on a channel associated with the tracking reference signal burst; and
sum the one or more weighted cross-correlation terms of the multiple pair combinations.

6. The UE of claim 5, wherein each weight of the one or more weights is further based at least in part on a Doppler frequency associated with the tracking reference signal burst and a product of a signal power and a normalized power of a respective independent tap of the channel.

7. The UE of claim 5, wherein the one or more cross-correlation terms of multiple pair combinations correspond to every pair combination of the three or more reference signal resources.

8. A user equipment (UE), comprising:
one or more memories storing processor-executable code; and
one or more processors coupled with the one or more memories and individually or collectively operable to execute the code to cause the UE to:
receive a tracking reference signal burst that includes two or more reference signal resources;
estimate a carrier frequency offset (CFO) based at least in part on a sum of weighted cross-correlation terms of multiple pair combinations of the two or more reference signal resources, wherein each weight of the weighted cross-correlation terms is based at least in part on a Doppler frequency associated with the tracking reference signal burst and a quantity of symbols between two respective reference signal resources of the two or more reference signal resources; and
participate in communications based at least in part on the CFO estimation.

9. The UE of claim 8, wherein the one or more processors are individually or collectively further operable to execute the code to cause the UE to:
adjust a frequency tracking loop of the UE to compensate for the CFO estimation based at least in part on a pull-in range associated with a greatest common denominator of the quantity of symbols, wherein participating in communications is further based at least in part on adjusting the frequency tracking loop.

10. The UE of claim 8, wherein the one or more cross-correlation terms of multiple pair combinations correspond to every pair combination of the two or more reference signal resources.

11. The UE of claim 8, wherein:
the two or more reference signal resources are positioned asymmetrically across one or more slots.

12. The UE of claim 11, wherein:
a first slot of the one or more slots comprises a first set of reference signal resources of the two or more reference signal resources and a second slot of the one or more slots comprises a second set of reference signal resources of the two or more reference signal resources, and
the first set is positioned asymmetrically in the first slot relative to the second set positioned in the second slot.

13. The UE of claim 11, wherein:
the two or more reference signal resources are positioned asymmetrically within one slot of the one or more slots, and
a spacing of the quantity of symbols between each of the two or more reference signal resources is non-uniform.

14. A method for wireless communications at a user equipment (UE), comprising:
receiving a tracking reference signal burst that includes three or more reference signal resources, wherein the three or more reference signal resources are positioned asymmetrically across one or more slots, and wherein a greatest common denominator of a quantity of symbols between combinations of the three or more reference signal resources is one;
estimating a carrier frequency offset (CFO) based at least in part on the three or more reference signal resources; and
participating in communications based at least in part on the CFO estimation.

15. The method of claim 14, further comprising:
adjusting a frequency tracking loop of the UE to compensate for the CFO estimation based at least in part on a pull-in range associated with the greatest common denominator, wherein participating in communications is further based at least in part on adjusting the frequency tracking loop.

16. The method of claim 14, wherein:
a first slot of the one or more slots comprises a first set of reference signal resources of the three or more reference signal resources and a second slot of the one or more slots comprises a second set of reference signal resources of the three or more reference signal resources, and
the first set is positioned asymmetrically in the first slot relative to the second set positioned in the second slot.

17. The method of claim 14, wherein:
the three or more reference signal resources are positioned asymmetrically within one slot of the one or more slots, and
a spacing of the quantity of symbols between each of the three or more reference signal resources is non-uniform.

18. The method of claim 14, wherein estimating the CFO comprises:
determining one or more weights for one or more cross-correlation terms of multiple pair combinations of the three or more reference signal resources based at least in part on a channel associated with the tracking reference signal burst; and
summing the one or more weighted cross-correlation terms of the multiple pair combinations.

19. The method of claim 18, wherein each weight of the one or more weights is further based at least in part on a Doppler frequency associated with the tracking reference signal burst and a product of a signal power and a normalized power of a respective independent tap of the channel.

20. The method of claim 18, wherein the one or more cross-correlation terms of multiple pair combinations correspond to every pair combination of the three or more reference signal resources.
